(19) United States
(12) Patent Application Publication
(10) Pub. No.: US 2009/0262146 A1
(43) Pub. Date: Oct. 22, 2009

(54) SOURCE DRIVER

(75) Inventor: Ken HASHIMOTO, Kyoto (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/368,086

(22) Filed: Feb. 9, 2009

(30) Foreign Application Priority Data
Feb. 8, 2008 (JP) JP2008-029108

(51) Int. Cl. G09G 5/10; G09G 3/36

(52) U.S. Cl. 345/690; 345/102

(57) ABSTRACT

A source driver performs inversion drive on a plurality of data lines of a liquid crystal panel. A differential interface receives brightness data of each pixel as a differential signal from a timing controller. A D/A converter converts the brightness data to a drive voltage of each pixel on the basis of a predetermined gamma correction curve according to the polarity of the inversion driving. An output buffer supplies the drive voltage of each pixel to a data line.

### BACKGROUND OF THE INVENTION

1. Field of the Invention

The present invention relates to a technique of driving a liquid crystal panel and, more particularly, to a source driver for driving a plurality of data lines.

2. Description of the Related Art

A liquid crystal panel has a plurality of data lines, a plurality of scan lines disposed so as to be orthogonal to the data lines, and a plurality of TFTs (Thin Film Transistors) disposed in a matrix at crossing points of the data lines and the scan lines. To drive the liquid crystal panel, a gate driver for sequentially selecting the plurality of scan lines and a source driver for applying a voltage according to brightness to each of the data lines are provided.
Patent document 1: Japanese Patent Application (Laid Open) No. H8-320674
Patent document 2: Japanese Patent Application (Laid Open) No. 2007-286526
Patent document 3: Japanese Patent Application (Laid Open) No. S62-50818
Patent document 4: Japanese Patent Application (Laid Open) No. H1-174186

There is a problem such that continuous impression of drive voltage of DC (direct current) to a data line deteriorates a liquid crystal panel. To solve the problem, in recent years, a method of alternately applying voltages of different polarities to the data lines like AC (alternating current) (inversion driving method) goes mainstream.

It is necessary to adjust a drive voltage corresponding to a certain tone in accordance with a gamma characteristic of a liquid crystal panel to be driven.

### SUMMARY OF THE INVENTION

The present invention has been achieved in view of such circumstances and a general purpose of the invention is to provide a source driver capable of performing inversion driving and adjusting the gamma characteristic.

An embodiment of the present invention relates to a source driver for inversion-driving a plurality of data lines of a liquid crystal panel. The source driver includes: an interface circuit which receives brightness data of each pixel from a timing controller as a differential signal; a digital-to-analog converter for converting the brightness data of each pixel to a drive voltage on the basis of a predetermined gamma correction curve according to the polarity of the inversion driving; and a plurality of buffers, each of which is provided for each of the data lines and supplying the drive voltage of each pixel to a corresponding data line.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing the configuration of a liquid crystal display having a source driver according to an embodiment;

FIG. 2 is a block diagram showing the configuration of the source driver according to the embodiment;

FIG. 3 is a time chart showing brightness data receiving operation in a differential interface;

FIG. 4 is a diagram showing the relation between a tone indicated by the brightness data and gradation voltage;

FIG. 5 is a circuit diagram showing the details of the configuration of a D/A converter and an output buffer;

FIGS. 6A to 6C are time charts showing a state of charge sharing in different modes; and

FIG. 7 is a pin layout diagram of the source driver.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

In the specification, “state where a member A is connected to a member B” includes a case where the members A and B are physically directly connected to each other and a case where the members A and B are indirectly connected to each other via another member which does not exert an influence on an electric connection state. Similarly, “state where a member C is provided between members A and B” includes a case where the members A and C or the members B and C are directly connected to each other and a case where the members A and C or the members B and C are indirectly connected to each other via another member which does not exert an influence on an electric connection state.

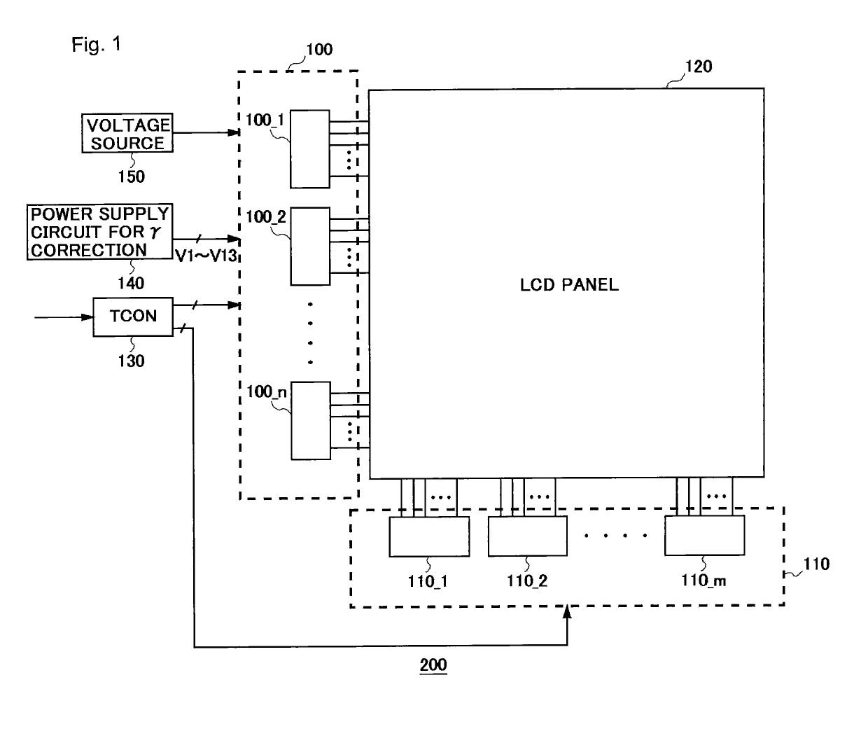

FIG. 1 is a block diagram showing the configuration of a liquid crystal display 200 having a source driver 100 as an embodiment. The liquid crystal display 200 is mounted on an electronic device such as a liquid crystal television, a computer, or a cellular phone terminal.

The liquid crystal display 200 has a liquid crystal panel 120, a plurality of (m pieces of) gate drivers 110_1 to 110_m (as necessary, generically called a gate driver 110), a plurality of (n pieces of) source drivers 100_1 to 100_n (as necessary, generically called a source driver 100), a timing controller 130, a power supply circuit 140 for gamma correction, and a voltage source 150.

The liquid crystal panel 120 has a plurality of data lines and a plurality of scan lines, and is provided with pixel circuits disposed in a matrix at cross points of the data lines and the scan lines. The gate driver 110 receives data from the timing controller 130 and sequentially applies and selects voltage to the plurality of scan lines. The source driver 100 receives brightness data D0 to D2 indicative of brightness of pixels output from the timing controller 130 together with clocks CK synchronized with the brightness data D0 to D2, and drives the plurality of data lines of the liquid crystal panel 120. The brightness data D0, D1, and D2 corresponds to the three primary colors of R, G, and B, respectively.

The source drivers 100_1 to 100_n are disposed along one side of the liquid crystal panel 120. The number “m” of the source drivers 100 is determined according to resolution of the liquid crystal panel 120. The source driver 100 is a function IC integrated on a single semiconductor substrate. A plurality of output terminals of the source driver 100 is connected to the corresponding data lines. To data input terminals of the source driver 100, the brightness data D0 to D2 of respective pixels are input from the timing controller 130.

The voltage source 150 is a circuit for generating high voltage for driving the data lines and the scan lines of the liquid crystal panel 120 and is constructed by a charge pump circuit and a switching regulator. A high voltage generated by the voltage source 150 is supplied to the gate driver 110 and the source driver 100.

The power supply circuit 140 for gamma correction generates a plurality of reference voltages V1 to V13 used for performing gamma correction which will be described later and outputs them to the source drivers 100_1 to 100_n.

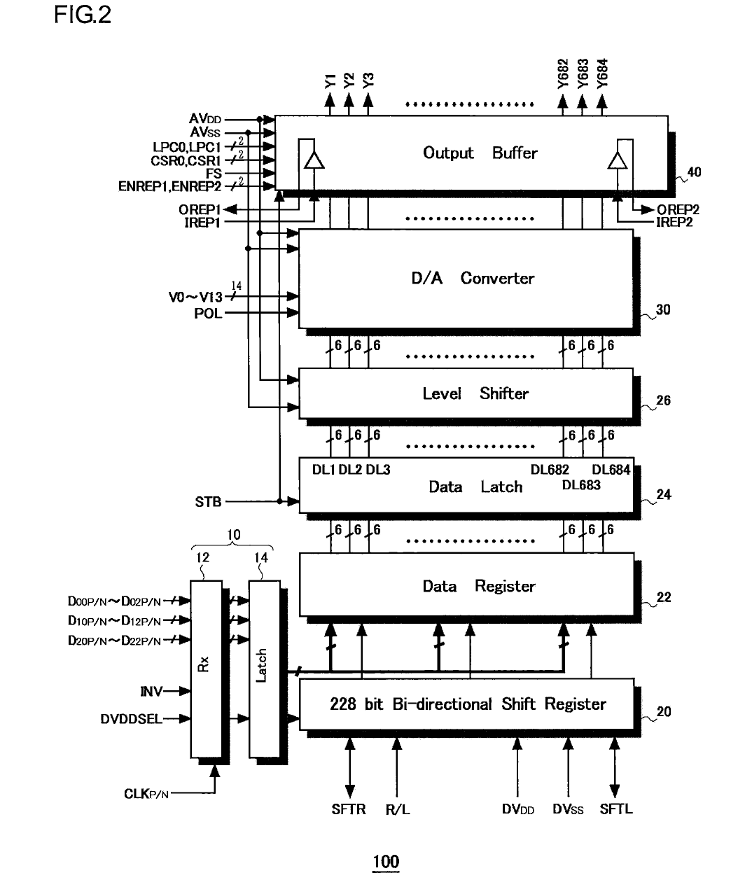

The general configuration of the liquid crystal display 200 has been described above. FIG. 2 is a block diagram showing the configuration of the source driver 100 of the embodiment. The source driver 100 has output terminals Y1 to Y684 connected to a plurality of (684 pieces of) data lines of the liquid crystal panel 120. The source driver 100 has a differential interface 10, a bidirectional shift register 20, a data register 22, a data latch circuit 24, a level shifter 26, a D/A converter 30, and an output buffer 40 and is a function IC integrated on a single semiconductor substrate.

The differential interface 10 receives brightness data D0P/N to D2P/N of difference signals output from the timing controller 130 together with a differential clock signal CLKP/N. P/N indicates a differential pair which will not be described below. Further, to the differential interface 10, a start pulse SFT indicative of a timing of fetching brightness data is input. The differential interface 10 includes a reception circuit 12 and a latch circuit 14.

The brightness data D0 to D2 is transmitted via three pairs of differential paths. Specifically, the brightness data D0 is parallel data of three bits made of brightness data D00, D01, and D02. Similarly, the brightness data D1 is parallel data including brightness data D10, D11, and D12. The brightness data D2 is parallel data including brightness data D20, D21, and D22.

Each of the brightness data D00 to D02, D10 to D12, and D20 to D22 has data of one bit at each of positive and negative edges of the differential clock signal CLK. That is, data of two bits is transmitted per clock every data line. In the embodiment, an image is displayed in 64 shades of gray of 6 bits in each of R, G, and B. Therefore, data of one pixel is transmitted in one cycle of the differential clock.

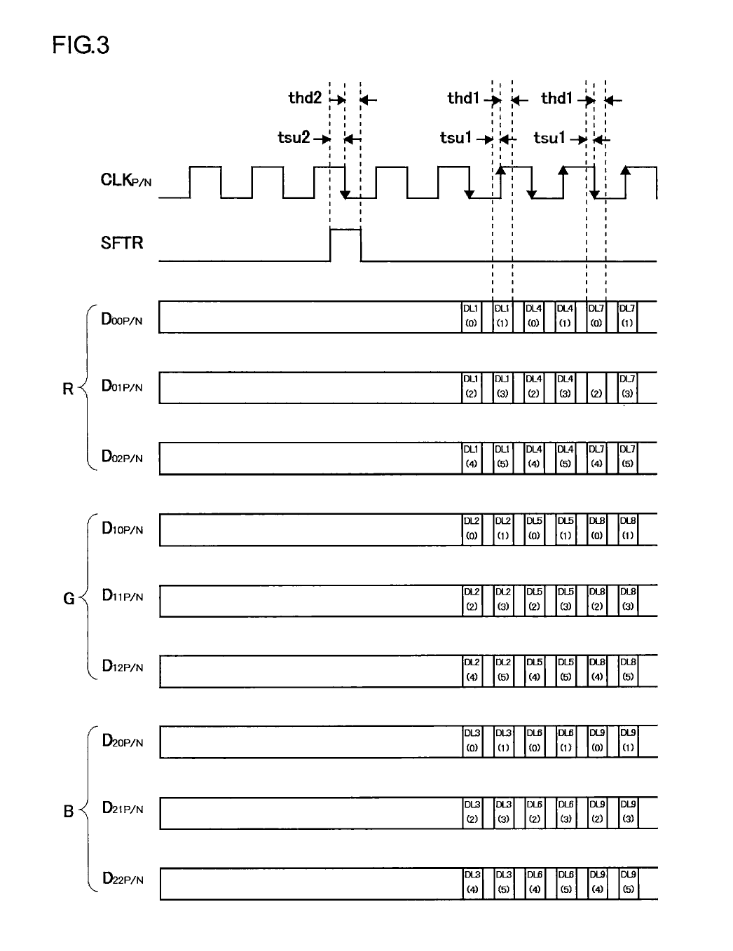

FIG. 3 is a time chart showing brightness data receiving operation in the differential interface 10. The differential clock CLKP/N shows only one of the differential pair. When the start pulse SFT becomes the high level, from the timing after two clocks, fetch of the brightness data D0, D1, and D2 starts. In the time chart of FIG. 3, a setup time “tsu” and a hold time “thd” are shown.

A data group with label DL1 indicates tone of drive voltage output to a data line via the output terminal Y1. Similarly, data groups with labels DL2, DL3, . . . indicate tones of drive voltage output to the data lines via the output terminals Y2, Y3, . . . . The latch circuit 14 latches the values of data at timings of the positive and negative edges of the differential clock signal CLKP/N.

In the case where the start pulse SFT becomes the high level twice, fetch of the brightness data D0 to D2 starts at a timing after two clocks of the timing when the start pulse SFT shifts to the high level at the second time.

The source driver 100 of the embodiment can switch between output of white and output of black when all of the brightness data is 1. On the basis of the value of the data inversion signal INV input to the differential interface 10, the source driver 100 switches between a normally white driving method and a normally black driving method. That is, all of bits of the brightness data are inverted according to the value of the data inversion signal INV.

Referring again to FIG. 2, the brightness data DL1 to DL684 latched by the latch circuit 14 is transferred to the data register 22. As described above, the data of three colors of R, G, and B is transmitted in one cycle of the differential clock signal CLKP/N. Therefore, the data DL1 to DL684 of 684 pixels is transmitted in time of 228 clocks (=684/3).

The bidirectional shift register 20 has registers in 228 stages between two terminals SFTR and SFTL, and shifts the start pulse SFT stage by stage every clock. The propagation direction of the start pulse SFT can be switched according to shift direction setting data R/L. Concretely, when the shift direction setting data R/L is H, the start pulse SFT propagates from the terminal SFTR to the terminal SFTL. When R/L is L, the start pulse SFT propagates from the terminal SFTL to the terminal SFTR.

As shown in FIG. 1, the plurality of source drivers 100_1 to 100_n are disposed so as to be adjacent to each other. When R/L=H, the start pulse SFT output from the terminal SFTL of a certain source drier 100 is input to the terminal SFTR of the neighboring source driver 100. On the contrary, when R/L=L, the start pulse SFT output from the terminal SFTR of a certain source driver 100 is input to the terminal SFTL of the neighboring source driver 100. In such a manner, synchronously with the differential clock signal, the start pulse SFT sequentially propagates through the plurality of source drivers 100.

By providing the bidirectional shift register 20 to switch the propagation direction in accordance with the shift direction setting data R/L, the direction of mounting the source driver 100 to the liquid crystal panel 120 can be flexibly designed.

Each of the data register 22 and the data latch circuit 24 has a memory space of 684 pixels×6 bits. When the start pulse SFT is positioned in the i-th (i=1 to 228) stage of the bidirectional shift register 20, the brightness data D0, D1, and D2 are written in addresses corresponding to the (i×3−2)th, (i×3−1)th, and (i×3)th data lines, respectively, in the data register 22. As a position of the start pulse SFT is shifted, the brightness data input to the differential interface 10 is sequentially written in the data register 22. After counting 228 clocks, all of the brightness data on one scan line is written in the data register 22. When a strobe signal which is input to the data latch circuit 24 becomes the high level, the data written in the data register 22 is transferred to the data latch circuit 24.

In the source driver 100, circuit blocks on the upstream side of the level shifter 26, that is, the differential interface 10, bidirectional shift register 20, data register 22, and data latch circuit 24 operate on the basis of power supply voltages DVDD and DVSS. For example, the circuits operate in a 3-V system. The rated voltage of the power supply voltages DVDD lies in the range of 2.3 V to 3.6 V. In the case of using the power supply voltage DVDD in the range of 2.7 V to 3.6 V, a power supply voltage selection signal DVDDSEL is set to the high level. In the case of using the power supply voltage DVDD in the range of 2.3 V to 3 V, the power supply voltage selection signal DVDDSEL is set to the low level.

On the other hand, circuit blocks on the downstream side of the level shifter 26, that is, the D/A converter 30 and the output buffer 40 operate in a 15-V system. The rated voltage of the power supply voltage AVDD lies in the range of 10 V to 16.5 V.

The level shifter 26 shifts the level of the voltage amplitude between the two circuit blocks operating in the different power supply voltage systems.

The D/A converter 30 converts the brightness data DL1 to DL684 of each pixel (every data line) to drive voltage on the basis of a predetermined gamma correction curve according to the polarity of inversion drive. To the D/A converter 30, polarity instruction data POL indicative of polarity and reference voltages V0 to V13 for gamma correction are input.

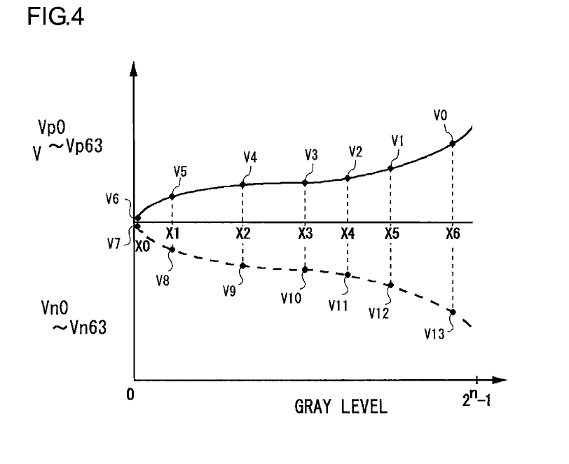

FIG. 4 is a diagram showing the relation between gray level indicated by brightness data and gradation voltage. The solid line shows gradation voltages Vp0 to Vp63 in the case of the first polarity. The broken line shows gradation voltages Vn0 to Vn63 in the case of the second polarity. The curves in FIG. 4 are set in accordance with the gamma characteristic of the liquid crystal panel 120. To be specific, a gradation voltage generating circuit 32 provided on the inside of the D/A converter 30 generates a plurality of gradation voltages Vp0 to Vp63 and Vn0 to Vn63 so as to be along the curves of FIG. 4.

Before explaining the configuration of the gradation voltage generating circuit 32, a method of generating the gradation voltages Vp0 to Vp63 and Vn0 to Vn63 by the gradation voltage generating circuit 32 will be described with reference to FIG. 4. The gradation voltage generating circuit 32 sets a plurality of representative gradation values (hereinbelow, called representative gradation values). For example, seven values discretely selected from all of the gray levels 0 to 63 are set as representative gradation values X0 to X6. The gradation voltages Vp0 to Vp63 (Vn0 to Vn63) corresponding to the representative gradation values X0 to X6 are set as reference gradation voltages V0 to V6 (V7 to V13). The representative gradation values X0 to X6 are set common to the first and second polarities.

A gradation voltage corresponding to an intermediate gradation in the representative gradation values X0 to X6 is generated by interpolating the reference gradation voltages V0 to V6 (or V7 to V13). Preferably, linear interpolation is used.

According to the method, by setting the representative gradation values and adjusting the reference gradation voltages corresponding to the representative gradation values, a gamma curve adapted to the characteristics of the liquid crystal panel 120 can be realized.

The D/A converter 30 selects the gradation voltages Vp0 to Vp63 and Vn0 to Vn63 according to the polarity of the inversion driving and the value of brightness data for the plurality of brightness data DL1 to DL684, and outputs the selected voltages as drive voltages Vd1 to Vd684 to the output buffer 40 at the post stage. The output buffer 40 has therein buffers BUF1 to BUF684 provided for the respective data lines. Each buffer BUF supplies an input drive voltage Vd to a corresponding data line.

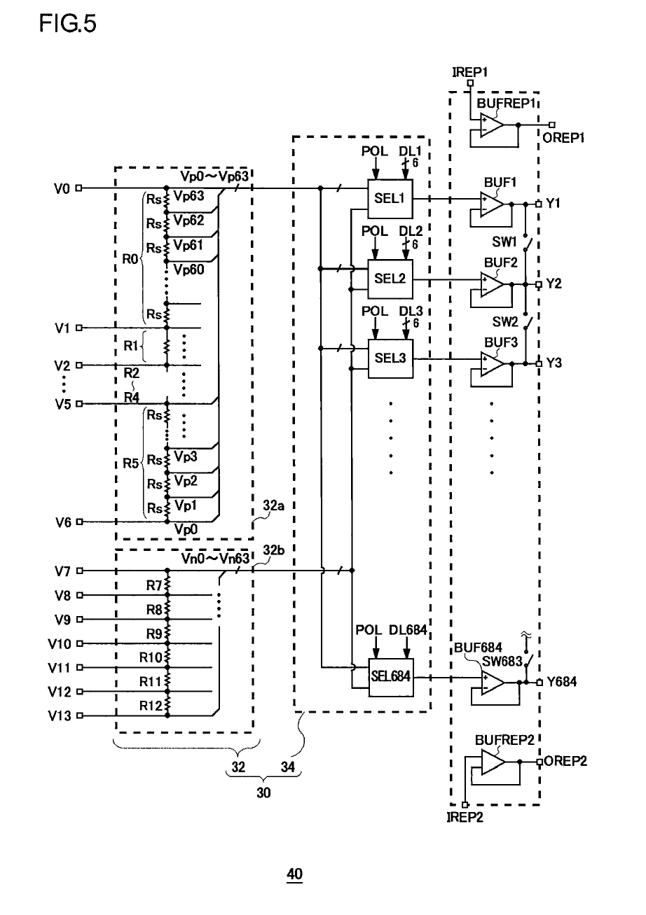

FIG. 5 is a circuit diagram specifically showing the configuration of the D/A converter 30 and the output buffer 40. The D/A converter 30 includes the gradation voltage generating circuit 32 and a selector circuit 34.

The gradation voltage generating circuit 32 includes a first gradation voltage generating circuit 32a for generating the gradation voltages Vp0 to Vp63 of the first polarity, and a second gradation voltage generating circuit 32b for generating the gradation voltages Vn0 to Vn63 of the second polarity. The first gradation voltage generating circuit 32a receives the reference voltages V0 to V6. Between neighboring reference voltages Vi and Vi+1, a resistor string Ri is provided. The resistor string Ri has sub-resistors Rs connected in series. All of the resistance values of the sub-resistors Rs are equal. At a plurality of taps provided between the neighboring sub-resistors Rs, a voltage obtained by dividing the reference voltages Vi and Vi+1 is generated. Voltages generated at the taps are output as the gradation voltages Vp0 to Vp63 of the first polarity. That is, the gradation voltages are generated by linearly-interpolating the reference voltages V0 to V6. Similarly, the second gradation voltage generating circuit 32b generates the gradation voltages Vn0 to Vn63 of the second polarity.

The selector circuit 34 includes a plurality of selectors SEL1 to SEL684 provided for the data lines. To the i-th selector SELi, the polarity instruction data POL and the i-th brightness data DLi gradation voltages Vp0 to Vp63 and Vn0 to Vn63 is input. When the polarity instruction data POL is 1, an even-numbered selector SELi selects a voltage according to the value of the brightness data DLi from the gradation voltages Vp0 to Vp63 of the first polarity. An odd-numbered selector SELi selects a voltage according to the value of the brightness data DLi from the gradation voltages Vn0 to Vn63 of the second polarity. When the polarity instruction data POL is 0, an even-numbered selector SELi selects a voltage according to the value of the brightness data DLi from the gradation voltages Vn0 to Vn63 of the second polarity. An odd-numbered selector SELi selects a voltage according to the value of the brightness data DLi from the gradation voltages Vp0 to Vp63 of the first polarity.

The output buffer 40 has a plurality of buffers BUF1 to BUF684 provided for the data lines. Each of the buffers BUF1 to BUF684 is a voltage follower using an operation amplifier. The i-th buffer BUFi receives an analog gradation voltage from the i-th selector SELi and outputs the analog gradation voltage from the output terminal Yi to the data line.

When an offset occurs in the operation amplifier included in the buffer, a problem occurs such that an error occurs between the input voltage of the buffer and the output voltage of the buffer and brightness is deviated from a desired value. To solve the problem, the inversion input terminal and the non-inversion input terminal of the operation amplifier of each buffer are interchangeable. While switching between the inversion input terminal and the non-inversion input terminal of the operation amplifier in accordance with the value of an offset cancel signal FS whose level changes frame by frame, the gradation voltage is supplied to the data line. By the function, in the case where an offset occurs in the operation amplifier due to variations in process, the influence of the offset can be reduced.

Next, a charge sharing function will be described. Each of the plurality of data lines of the liquid crystal panel 120 has parasitic capacitance. In the case of inversion-driving the liquid crystal panel 120, each time the polarity of driving is switched, the potential of the data line largely fluctuates around the common voltage as a center. Consequently, charges accumulated in the capacity of the data line are discarded. This is unpreferable from the viewpoint of power consumption, so that the source driver 100 of the embodiment is provided with the charge sharing function. The charge sharing function is a technique of sharing charges by coupling the plurality of data lines to reduce consumption current.

The charge sharing function is realized by a plurality of switches SW1 to SW683 provided between neighboring output terminals Y. The charge sharing function is realized in any of the following three modes. The mode of the charge sharing is set according to the value of control data CSR0 and CSR1.

1. First Mode (CSR0=L, CSR1=L)

Referring to the polarity instruction data POL, only when the drive polarity changes between neighboring frames, the switches SW1 to SW683 are turned on to perform the charge sharing.

2. Second Mode (CSR0=L, CSR1=H)

Regardless of a change in the polarity, the switches SW1 to SW683 are turned on frame by frame to perform the charge sharing.

3. Invalidation Mode (CSR0=H)

The switches SW1 to SW683 are normally off and the charge sharing is not performed.

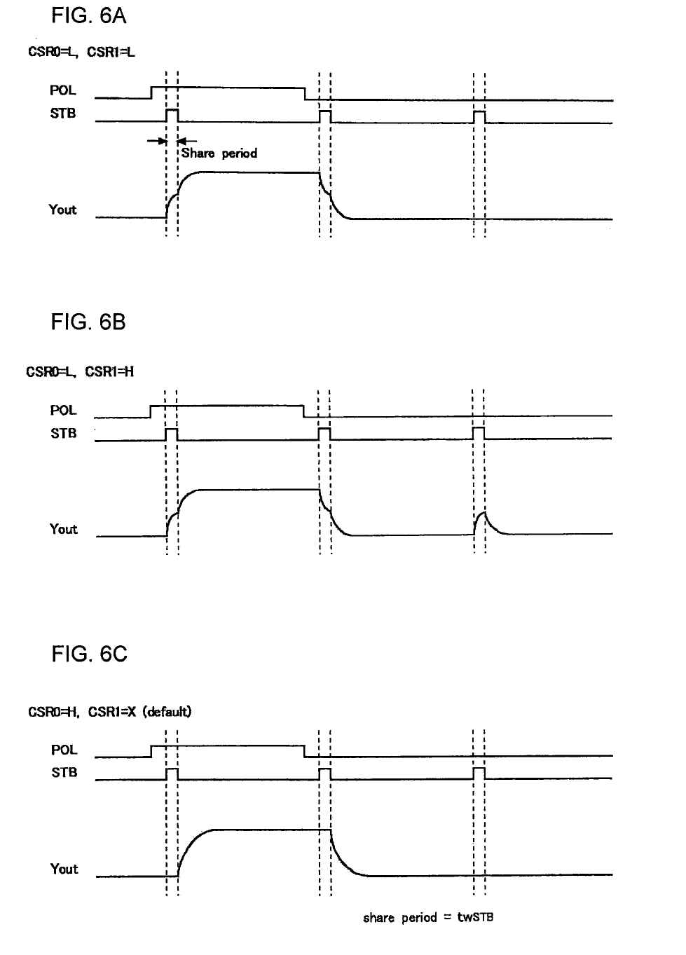

FIGS. 6A to 6C are time charts showing states of the charge sharing in the modes. FIG. 6A shows the first mode, FIG. 6B shows the second mode, and FIG. 6C shows the invalidation mode.

Referring again to FIG. 5, the output buffer 40 has, in addition to the buffers BUF1 to BUF684, buffers BUFREP1 and BUFREP2 for repair. Usually, input terminals IREP and output terminals OREP of the two buffers BUFREP1 and BUFREP2 for repair are not-connected (NC) and used in an open state.

In the case where a defect exists in the i-th data line in the liquid crystal panel 120 and the i-th data line is interrupted in some midpoint, a problem occurs such that, of pixels connected to the data line, the pixels from the output terminal Yi of the output buffer 40 to the interrupted place operate, but no drive voltage is supplied to the pixels further than the interrupted place. In the case where disconnection occurs in the i-th data line, the input terminal IREP of the buffer BUFREP for repair is connected to the i-th output terminal Yi. The output terminal OREP of the buffer BUFREP for repair is connected to the other end (the side opposite to the output terminal Yi) of the i-th data line. By the process, the drive voltage is supplied to the pixels further than the interrupted place, and brightness can be controlled. By providing the two buffers BUFREP1 and BUFREP2 for repair, a failure in two data lines can be handled.

To the output buffer 40, enable signals ENREP1 and ENREP2 for instructing the presence or absence of operation of the buffers BUFREP1 and BUFREP2 for repair are input. The buffers BUFREP1 and BUFREP2 for repair operate only when the corresponding enable signals ENREP are at the high level. The buffers BUFREP1 and BUFREP2 for repair completely shut down to reduce power consumption when the corresponding enable signals ENREP are at the low level.

The buffers BUF1 to BUF684, BUFREP1, and BUFREP2 in the output buffer 40 can switch the bias current in four stages. With the configuration, the slew rate can be controlled according to a load. A bias current of the buffer is set in accordance with the values of low power consumption control signals LPC0 and LPC1 of two bits. With the function, the designer of the set can switch between priority on power consumption and priority on the slew rate of the buffer (that is, display speed of the liquid crystal), and the flexibility of designing increases.

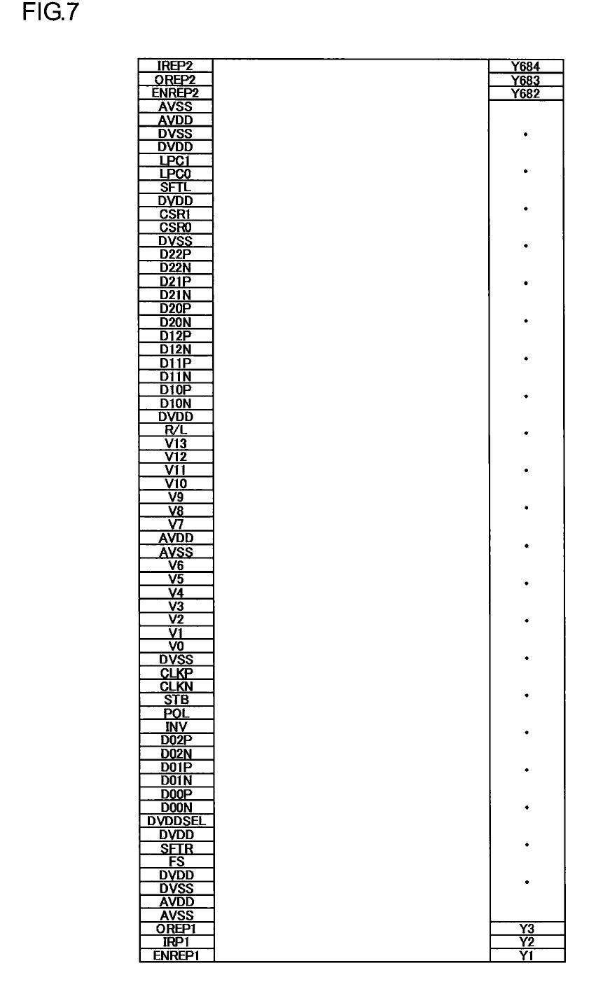

FIG. 7 is a pin layout diagram of the source driver 100 in the embodiment, which is a top view of the chip. The output terminals Y1 to Y684 are disposed along one side, and the other pins are disposed along another side. At both ends of another side, input/output pins of the buffers for repair and the enable pins (IREP2, OREP2, ENREP2, IREP1, OREP1, and ENREP1) and the like are disposed. By disposing the pins at both ends, connection to a panel is facilitated.

In addition, the input pins (D00 to D02, D10 to D12, and D20 to D22) of brightness data, the input pins (V1 to V13) for gamma correction voltage, the input pin (CLKP/N) for clock, power source pins (AVDD, AVSS, DVDD, and DVSS), start signal input/output terminals (SFTR and SFTL), and other pins for control signals are provided.

The configuration and operation of the source driver 100 of the embodiment have been described above. With the source driver 100, the inversion drive and adjustment of the gamma characteristic can be realized.

While the preferred embodiments of the present invention have been described using specific terms, such description is for illustrative purposes only, and it is to be understood that changes and variations may be made without departing from the spirit or scope of the appended claims.

1. A source driver which performs inversion driving on a plurality of data lines of a liquid crystal panel, comprising:
an interface circuit which receives brightness data of each pixel from a timing controller as a differential signal;
a digital-to-analog converter which converts the brightness data of each pixel to a drive voltage on the basis of a predetermined gamma correction curve according to polarity of the inversion driving; and
a plurality of buffers, each of which is provided for each of the data lines and supplies the drive voltage of each pixel to a corresponding data line.

2. The source driver according to claim 1, further comprising:
a shift register including registers in a plurality of stages and shifting a start pulse stage by stage;
a data register which sequentially stores the brightness data received by the interface circuit into an address according to a position of the start pulse of the shift register; and
a data latch circuit, when all of the brightness data on one scan line is stored in the data register and a strobe signal is asserted, which latches the data stored in the data register, wherein
the digital-to-analog converter converts the brightness data held by the data latch circuit to drive voltage.

3. The source driver according to claim 1, wherein
the digital-to-analog converter includes a gradation voltage generating circuit and a selector circuit,
the gradation voltage generating circuit includes:
a first gradation voltage generating circuit which receives a plurality of reference voltages and generates a set of gradation voltages of a first polarity by linear interpolation; and
a second gradation voltage generating circuit which receives a plurality of reference voltages and generates a set of gradation voltages of a second polarity by linear interpolation, and
the selector circuit includes a plurality of selectors provided for the data lines, and each of the selectors receives the sets of the gradation voltages of the first and second polarities, and selects one of the sets of the gradation voltages, according to the polarity of the inversion driving, in accordance with the brightness data.

4. A liquid crystal display comprising:
a display panel having a plurality of data lines, a plurality of scan lines, and pixel circuits disposed in a matrix at crossing points of the data lines and the scan lines;
a timing controller;
a power supply circuit for gamma correction which generates a plurality of reference voltages;
a gate driver which sequentially selects the plurality of scan lines synchronously with signals from the timing controller; and
a source driver which performs inversion driving on a plurality of data lines of a liquid crystal panel, comprising:
an interface circuit which receives brightness data of each pixel from a timing controller as a differential signal;
a digital-to-analog converter which converts the brightness data of each pixel to a drive voltage on the basis of a predetermined gamma correction curve according to polarity of the inversion driving; and
a plurality of buffers, each of which is provided for each of the data lines and supplies the drive voltage of each pixel to a corresponding data line; wherein
the digital-to-analog converter comprises a gradation voltage generating circuit and a selector circuit,
the gradation voltage generating circuit comprises:
a first gradation voltage generating circuit which receives a plurality of reference voltages and generates a set of gradation voltages of a first polarity by linear interpolation; and
a second gradation voltage generating circuit which receives a plurality of reference voltages and generates a set of gradation voltages of a second polarity by linear interpolation, and
the selector circuit comprises a plurality of selectors provided for the data lines, and each of the selectors receives the sets of the gradation voltages of the first and second polarities, and selects one of the sets of the gradation voltages, according to the polarity of the inversion driving, in accordance with the brightness data; wherein the source driver receives the brightness data indicative of brightness of each pixel output from the timing controller and the plurality of reference voltages and drives the plurality of data lines.
